(19) United States
(12) Patent Application Publication
(10) Pub. No.: US 2009/0301802 A1
(43) Pub. Date: Dec. 10, 2009

(54) PEM fuel cell auxiliary power system and method for starting an internal combustion engine vehicle

(76) Inventors: Melanie A. LaRocco, Manchester, CT (US); Margaret M. Steinbugler, East Windsor, CT (US); Wolfgang Strobl, Eichstaett (DE); Ingo Falkenberg, Muenchen (DE)

Correspondence Address: William W. Jones, 6 Juniper Lane, Madison, CT, 06443, US

(21) Appl. No.: 12/156,798

(22) Filed: Jun. 5, 2008

(51) Int. Cl. B60K 1/04

(52) U.S. Cl. 180/65.31; 429/13; 903/944

(57) ABSTRACT

An internal combustion engine vehicle includes a compact light weight PEM fuel cell auxiliary power system (2) which is used to provide electrical power for operating the vehicle starter (10) to start the vehicle, and for operating additional electrical equipment while the vehicle is running, or before the vehicle is running. A small light weight dry cell battery (4) is included in the vehicle for supplying startup power for the PEM fuel cell auxiliary power system. The conventional heavy and bulky twelve volt battery is not needed in the vehicle thereby eliminating the weight and size of the twelve volt battery from the vehicle. A bank of super capacitors (18) can be included in the vehicle which are operatively connected to the PEM fuel cell auxiliary power system and to the starter. The super capacitors can be charged by the PEM fuel cell auxiliary power system during operation of the vehicle, and can be activated to provide startup electrical power to the starter along with the PEM fuel cell auxiliary power system so as to start the vehicle in adverse ambient conditions, such as during subfreezing weather.

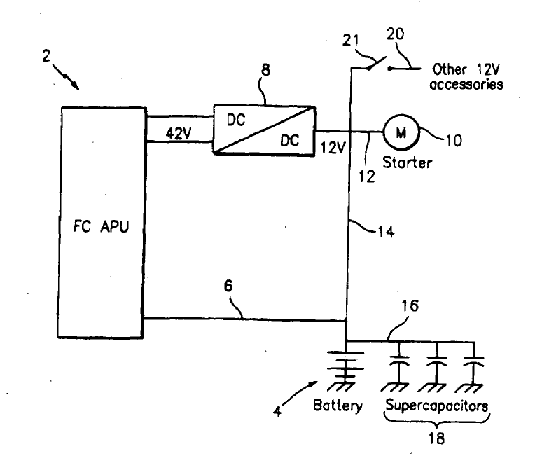

### TECHNICAL FIELD

The present invention relates to a system and use employing an auxiliary polymer electrolyte membrane (PEM) fuel cell auxiliary power system for starting an internal combustion engine vehicle as well as for operating auxiliary equipment such as an air conditioner, a heater, radio, and the like, in the vehicle.

### BACKGROUND OF THE INVENTION

Polymer electrolyte membrane fuel cell assemblies are relatively low temperature low operating pressure fuel cell assemblies that utilize a catalyzed polymer membrane electrolyte to process air and a hydrogen-rich fuel to produce electricity and water. PEM fuel cells are well suited for use in mobile applications such as automobiles, buses, trucks, and the like, because they are relatively compact, light in weight and operate at essentially ambient pressure. PEM fuel cell power plants include a conventional catalyzed polymer membrane electrode having an anode side which receives a hydrogen-rich fuel stream and a cathode side which receives an air reactant stream. A coolant flow field is disposed in heat exchange relationship with the cathode side of the fuel cells so as to cool the fuel cells during operation thereof. The coolant used in PEM fuel cell power systems is typically water. It has been proposed to use relatively small PEM power plants in internal combustion engine-powered vehicles for providing power to operate auxiliary electrical equipment in the vehicles, such as a radio, air conditioner, heater, headlights and taillights, and the like. These small fuel cell power plants are used as an adjunct to the conventional bulky and heavy 12 volt battery used in the vehicle to start the vehicle and to provide electricity to operate the auxiliary electrical equipment while the vehicle is running.

It would be desirable to be able to eliminate the need for large and bulky conventional 12 volt batteries in the vehicle and use compact light weight auxiliary PEM fuel cells as the main source of electricity to both start the vehicle and to power the electrical equipment in the vehicle both during pre-startup and while the vehicle is being operated.

### DISCLOSURE OF THE INVENTION

This invention relates to the use of PEM type of fuel cell assemblies in internal combustion engine-powered vehicles to provide electricity for operating auxiliary electrical equipment in the vehicles, such as air conditioners, heaters, head lights and tail lights, and any other electrical systems which are presently powered by conventional twelve volt batteries and for starting the vehicle so as to render the twelve volt battery unnecessary. The PEM fuel cell auxiliary power systems which are suitable for use in conjunction with this invention are typically relatively small power systems that will produce nominally forty two volts of electrical output when in operation. These power systems will include about fifty or so cells to produce the desired power levels. The PEM fuel cell auxiliary power system can utilize pure hydrogen as a fuel source for the production of electricity.

The fuel cell power plant operating system can include a DC to DC converter which will convert the voltage produced by the PEM fuel cell auxiliary power system to a voltage appropriate for use in the vehicle. The operating system will also include a small battery which will provide the power necessary to start operation of the PEM fuel cell auxiliary power system. The PEM cell assembly can be activated prior to starting the vehicle if so desired so as to provide preliminary heating or cooling of the vehicle prior to use if so desired. The operating system can also include one or more super capacitors which can be selectively connected to the vehicle starter if necessary. The super capacitors can be charged by the PEM fuel cell auxiliary power system during periods of normal operation of the vehicle.

The normal operating procedure for the operating system is first to start the PEM fuel cell auxiliary power system with the small battery. The small battery is a small and single 12 volt battery which preferably has a capacity of about 0.3 ampere-hours and a maximum discharge current of about 20 amperes. The electrical current of the small battery used in this system is only about 200 watts. The small battery used in this system is substantially less bulky and much lighter than a conventional 12 volt automobile battery. After an initial time period whereupon the PEM fuel cell auxiliary power system will connect to the vehicle starter to start the vehicle, or to energize selected ones of the vehicle's auxiliary electrical devices, as noted above, prior to starting the vehicle. In the event that the charge from the fuel cells is insufficient to turn the starter over, the system will use one or more of the super capacitors in conjunction with the fuel cells to provide the necessary short burst of high energy needed to start the vehicle. Once the vehicle starts, the PEM fuel cell auxiliary power system can be switched to a lower power level for continued operation as the vehicle is driven. As noted above, energy from the PEM fuel cell auxiliary power system can be used to recharge the super capacitors in the event that their use was necessary to start the vehicle.

### BRIEF DESCRIPTION OF THE DRAWINGS

Certain objects and advantages of this invention will become more readily apparent to one skilled in the art from the following detailed description of a preferred embodiment of the invention when taken in conjunction with the accompanying drawing which is a schematic view of a vehicle startup and operating power system which utilizes a PEM fuel cell assembly for the electrical energy needed to operate the vehicle.

### SPECIFIC MODE FOR CARRYING OUT THE INVENTION

Referring now to the drawing there is shown a schematic view of a vehicle startup and operating power system which utilizes a PEM fuel cell auxiliary power system and system for providing the electrical energy needed to start and operate all of the electrical equipment in the vehicle. The PEM fuel cell auxiliary power system is denoted generally by the numeral 2, and as noted above, is a relatively small unit that has about fifty or so cells in it. A small dry cell battery 4 of the type described above is operatively connected to the PEM fuel cell auxiliary power system 2 via a line 6. The battery 4 is used to start up the PEM fuel cell auxiliary power system 2 by activating any fans and pumps which form a part of the PEM fuel cell auxiliary power system 2. The battery 4 can be selectively activated by a switch (not shown). Once activated, the electrical output from the PEM fuel cell auxiliary power system 2 will be in the range of about thirty to fifty volts DC, and preferably about forty two volts. In a vehicle which operates with a conventional twelve volt battery, the voltage from the PEM fuel cell auxiliary power system 2 will be directed to a DC/DC voltage converter 8 which has a twelve volt output that is suitable for operating the vehicle. The starter 10 of the vehicle is connected to the converter 8 through a line 12. A bank of super capacitors 18 is connected to a line 16 which, in turn, is connected to a line 14 leading to the starter 10 via line 12 and also to the converter 8.

If the vehicle operates with a higher voltage electrical system, such as with the forty two volt output of the PEM fuel cell auxiliary power system 2, the converter 8 can be eliminated from the startup system, and the voltage output of the PEM fuel cell auxiliary power system 2 can be used to power the starter and the auxiliary electrical equipment in the vehicle.

The system operates as follows. To begin vehicle startup, a switch is activated which connects the small light weight battery 4 to the PEM fuel cell auxiliary power system 2 thereby beginning operation of the PEM fuel cell auxiliary power system 2 and generating electricity that is fed to the converter 8. After a ramp up time period, the PEM fuel cell auxiliary power system 2 is brought up to a maximum current output stage and the converter 8 is electrically connected to the starter 10 so as to activate the latter to start the vehicle. There may be ambient conditions, such as subfreezing temperatures, that may hinder operation of the starter 10 by current derived solely from the PEM fuel cell auxiliary power system 2. In those cases, current from the PEM fuel cell auxiliary power system 2 and from one or more of the super capacitors 18 will be combined and directed to the starter 10. Once the vehicle is started, a switch 21 in the line 20 is dosed so as to provide power to all of the other electrical appliances in the vehicle.

It will be appreciated that the use of electricity produced by a small PEM fuel cell auxiliary power system to provide electrical power to operate electrical equipment in an internal combustion vehicle and to start the engine in the vehicle will allow one to dispense with the twelve volt battery in the vehicle completely. This will decrease the weight of the vehicle and provide a more durable electrical power source for the vehicle than is now the case.

Since many changes and variations of the disclosed embodiment of the invention may be made without departing from the inventive concept, it is not intended to limit the invention otherwise than as required by the appended claims.

What is claimed is:

1. A system for starting an internal combustion engine-powered vehicle, said system comprising:
a) a PEM fuel cell auxiliary power system (2) mounted in the vehicle;
b) a small light weight battery (4) providing a maximum discharge current of about 20 amperes and an electrical power of about only about 200 watts for providing start up power for said PEM fuel cell auxiliary power system; and
c) a starter (10) operatively connected to said PEM fuel cell auxiliary power system whereby electrical power from said PEM fuel cell auxiliary power system can be directed to said starter to activate the latter to start the vehicle engine.

2. The system of claim 1 further comprising a converter (8) operatively connected to said PEM fuel cell auxiliary power system for converting the voltage output of said PEM fuel cell auxiliary power system to twelve volt output;

3. The system of claim 1 wherein said PEM fuel cell auxiliary power system produces about forty two volts at full power.

4. The system of claim 1 further comprising at least one supplemental source (18) of electrical power selectively connected to said starter, said supplemental source being activated when power from said converter is insufficient by itself to start the vehicle engine.

5. The system of claim 4 wherein said supplemental source of electrical power includes one or more capacitors.

6. The system of claim 5 wherein said capacitors are super capacitors.

7. The system of claim 6 wherein said supplemental source includes three super capacitors.

8. A method for energizing an internal combustion engine-powered vehicle starter so as to start the vehicle, said method comprising:
a) the step of providing a PEM fuel cell auxiliary power system (2) mounted in the vehicle;
b) the step of powering up said PEM fuel cell auxiliary power system so as to provide voltage output therefrom; and
c) the step of using the voltage output from said PEM fuel cell auxiliary power system to energize the vehicle starter (10) so as to start the vehicle engine.

9. The method of claim 8 further including the step of converting the voltage output from said PEM fuel cell auxiliary power system to twelve volts;

10. The method of claim 8 further comprising the step of producing about forty two volts with said PEM fuel cell auxiliary power system.

11. The method of claim 8 further comprising the step of activating at least one supplemental source (18) of electrical power selectively connected to said starter when power from said PEM fuel cell auxiliary power system is insufficient by itself to start the vehicle engine.

12. The method of claim 11 wherein said supplemental source of electrical power includes one or more capacitors.

13. The method of claim 12 wherein said capacitors are super capacitors.

14. The method of claim 13 wherein said supplemental source includes three super capacitors.
